(19) United States
(12) Patent Application Publication
(10) Pub. No.: US 2022/0340438 A1
(43) Pub. Date: Oct. 27, 2022

(54) SELECTIVE EXTRACTION OF LITHIUM FROM LITHIUM SULFATE AQUEOUS SOLUTION

(71) Applicant: UT-Battelle, LLC, Oak Ridge, TN (US)

(72) Inventors: M. Parans Paranthaman, Knoxville, TN (US); Bruce A. Moyer, Oak Ridge, TN (US); Tej Nath Lamichhane, Melrose, MA (US)

(21) Appl. No.: 17/725,902

(22) Filed: Apr. 21, 2022

Related U.S. Application Data
(63) Continuation of application No. 63/177,995, filed on Apr. 22, 2021.

(51) Int. Cl. C01D 15/02; B01J 20/08

(52) U.S. Cl. CPC C01D 15/02; B01J 20/08; C01P 2002/72

(57) ABSTRACT

A method of selectively extracting lithium from a lithium sulfate aqueous solution, the method comprising: (i) mixing an aluminum-containing sorbent material into the lithium sulfate aqueous solution to form a precursor mixture, wherein the aluminum-containing sorbent material is an aluminum hydroxide, aluminum oxide, or combination thereof; and (ii) heating the precursor mixture to a temperature of 50-200° C. to result in selective formation of a solid lithium-aluminum complex and mother liquor; and wherein the method may further comprise: (iii) recovering isolated lithium salt from the solid lithium-aluminum complex by heating the solid lithium-aluminum complex in water or aqueous solution at a temperature of 50-100° C. to result in delithiation of the solid lithium-aluminum complex with transfer of the lithium salt from the solid lithium-aluminum complex to the water or aqueous solution, along with production of aluminum hydroxide solid.

### CROSS-REFERENCE TO RELATED APPLICATIONS

The present application claims benefit of U.S. Provisional Application No. 63/177,995 filed Apr. 22, 2021, all of the contents of which are incorporated herein by reference.

### STATEMENT REGARDING FEDERALLY SPONSORED RESEARCH

This invention was made with government support under Prime Contract No. DE-AC05-000R22725 awarded by the U.S. Department of Energy. The government has certain rights in the invention.

### FIELD OF THE INVENTION

The present invention generally relates to methods for extracting lithium from aqueous solutions, and more particularly, to methods in which a lithium salt is selectively removed from aqueous solutions even when in the presence of other alkali metal ions.

### BACKGROUND OF THE INVENTION

Lithium is of growing importance as an element for use in a variety of applications, particularly lithium-ion batteries. Economically viable concentrations of lithium are typically found in brines, minerals, and clays in various parts of the world. At one time, lithium production was dominated by producers utilizing spodumene and pegmatite mineral deposits found in the United States. However, South America, Australia, and China currently account for the majority of lithium production.

While hard minerals, such as pegmatite, still account for a significant fraction of lithium production, the majority is recovered from hard rock sources and continental brines. Lithium recovery is often accomplished using natural evaporative processes, which are very energy intensive and often inefficient in separating lithium from other metals. In some instances, the primary product of such brine processing is potassium, with lithium being produced as a side product.

As lithium has gained importance as an element for use in various applications, there are continuing efforts to develop less costly and more efficient methods for the recovery of lithium. In particular, there have been significant efforts in the use of layered lithium aluminates, typically of the formula LiX/Al(OH)₃, such as described in, for example, U.S. Pat. Nos. 9,012,357, 8,901,032, 8,753,594, 8,637,428, 6,280,693, 4,348,295, and 4,461,714 and U.S. Application Publication Nos. 2014/0239224 and 2018/0056283. Unfortunately, such methods, which generally employ packed columns for the recovery, suffer from a number of drawbacks, such as shortened lifetimes due to the gradual deterioration and disintegration of the particles and collapse of the crystal structures. Lithium-manganese oxide compositions have also been used, but they tend to suffer from instability from the use of concentrated acid to recover lithium from the sorbent. The use of packed columns, normally even with the best equipment designs, cannot prevent mixing of loading and regeneration streams, which results in contamination of even the most selective of sorbent materials.

Thus, there would be a significant benefit in a less costly, more straight-forward, and more efficient method for the recovery of lithium. There would be a further advantage in a method that could achieve a selective recovery of a lithium salt from a mixture of lithium and one or more other salts, such as salts of sodium, potassium, calcium, strontium, and magnesium.

### SUMMARY OF THE INVENTION

The present disclosure is foremost directed to a simple and cost effective method for extracting lithium from an aqueous solution, particularly an aqueous sulfate solution. The method also advantageously extracts lithium very selectively, even when the lithium salt is in the presence of much higher concentrations of non-lithium salts, such as sodium and potassium salts.

The method more specifically includes the following steps: (i) mixing an excess of an aluminum-containing sorbent material into the lithium sulfate aqueous solution to form a precursor mixture, wherein the aluminum-containing sorbent material is an aluminum hydroxide, aluminum oxide, or combination thereof; and (ii) heating the precursor mixture to a temperature of 50-200° C. to result in selective formation of a solid lithium-aluminum complex and mother liquor. In some embodiments, the lithium sulfate aqueous solution at the start of step (i) includes lithium in a concentration of at least 1000 ppm, sodium in a concentration of at least 1000 ppm, and potassium in a concentration of at least 1000 ppm. In some embodiments, the lithium sulfate aqueous solution at the start of step (i) includes lithium in a concentration of less than 1000 ppm, sodium in a concentration of at least 1000 ppm, and potassium in a concentration of at least 1000 ppm. In some embodiments, the lithium sulfate aqueous solution at the start of step (i) further includes at least one ionic species selected from sodium and potassium. In some embodiments, the lithium sulfate aqueous solution at the start of step (i) further includes at least one ionic species selected from calcium, strontium, and magnesium. In some embodiments, the lithium sulfate aqueous solution at the start of step (i) further includes at least one ionic species selected from sodium and potassium, and at least one additional ionic species selected from calcium, strontium, and magnesium. In embodiments, the lithium concentration in the mother liquor, at the end of step (ii), is no more than or less than 20%, 10%, 5%, 2%, or 1% of the lithium concentration in the lithium sulfate aqueous solution at the start of step (i) while concentrations of sodium and potassium (if present) in the lithium sulfate aqueous solution at the end of step (ii) remain substantially unchanged. The pH of the lithium sulfate aqueous solution at the start of step (i) is typically within a range of 1-14, or more particularly, a range of 8-14 or 8-11. In some embodiments, the lithium-aluminum complex has the formula (1/x)LiₓY.2Al(OH)₃, wherein Y is OH or SO₄; x is 1 when Y is OH; and x is 2 when Y is SO₄.

In some embodiments, the aluminum-containing sorbent material is selected from Al(OH)₃, MAlO₂, Al₂O₃, MAl(OH)₄, M₂O.Al₂O₃, and AlO(OH), wherein M is typically selected from Na, K, Rb, and Cs. In some embodiments, the aluminum-containing sorbent material is selected from Al(OH)₃, or more particularly, gibbsite. In other embodiments, the aluminum-containing sorbent material is selected from MAl(OH)₄ or MAlO₂, or more specifically, NaAl(OH)₄ or NaAlO₂.

In some embodiments, the method further includes, after step (ii): a step (iii) of recovering isolated lithium salt from the solid lithium-aluminum complex by heating the solid lithium-aluminum complex in water at a temperature of 50-100° C. to result in delithiation of the solid lithium-aluminum complex with transfer of the lithium salt from the solid lithium-aluminum complex to the water, along with production of aluminum hydroxide solid. Notably, the aluminum hydroxide, as regenerated in step (iii), can be re-used as the sorbent material in step (i).

In some embodiments, before step (i), the lithium sulfate aqueous solution is produced by: (a) heating lithium-containing mineral at a temperature of 600-1100° C. in the presence of a sulfating reactant to form a sulfated solid product; (b) leaching the sulfated solid product with water or an aqueous solution to form a leachate; and (c) filtering the leachate from solids to produce the lithium sulfate aqueous solution. The sulfating reactant may be or include one or more of, for example, gypsum, alkali sulfates, and alkaline earth sulfates. In some embodiments, any of the foregoing sulfating reactants is combined with limestone or calcium carbonate.

### BRIEF DESCRIPTION OF THE DRAWINGS

FIG. 1. Schematic of an exemplary lithium removal and isolation process.

FIG. 2. XRD patterns of lithium-aluminum complexes formed by reacting sodium aluminate with leachate solution. ICP results and pH of the leachate solutions are shown.

FIG. 3. X-ray powder diffraction patterns showing presence of LDH sulfate (bottom) after the first lithiation (sorbent) process and regeneration of Al(OH)₃ (top) after a delithiation process.

FIG. 4. X-ray powder diffraction patterns showing presence of hydrated lithium sulfate (bottom) from the evaporated mother liquor after delithiation of LDH sulfate.

### DETAILED DESCRIPTION OF THE INVENTION

The present method selectively extracts lithium from a lithium sulfate aqueous solution. The lithium sulfate aqueous solution can be obtained by any suitable process or source and contain lithium in any concentration. The lithium sulfate aqueous solution may be from, for example, a brine or industrial effluent and have any of the pHs described below. In some embodiments, the lithium sulfate aqueous solution is produced by a mineral sulfating process according to the following steps: (a) heating lithium-containing mineral at a temperature of 600-1100° C. in the presence of a sulfating reactant (typically as a dry roast) to form a sulfated solid product; (b) leaching the sulfated solid product with water or an aqueous solution to form a leachate; and (c) filtering the leachate from solids to produce the lithium sulfate aqueous solution. The lithium-containing mineral may be or include, for example, spodumene, pegmatite, petalite, lepidolite, mine tailings, or any combination thereof. The sulfating reactant is any material or combination of materials containing sulfate. Some examples of sulfating reactants include gypsum, alkali sulfates (e.g., sodium sulfate or potassium sulfate), alkaline earth sulfates (e.g., magnesium sulfate or calcium sulfate), and aluminum sulfate, or any combination thereof. In some embodiments, a carbonate material, or more particularly, an alkaline earth carbonate material (e.g., limestone or calcium carbonate) is added in combination with the sulfating agent to function as a flux to reduce the melting temperature of the mixture and precipitate an alkaline earth silicate from the mineral.

In typical embodiments, the lithium-containing mineral is ground to a particulate form (typically, 1-5000 microns) and heated, typically in the dry state, in the presence of the sulfating reactant and optional carbonate material at a temperature of precisely or about, for example, 600° C., 650° C., 700° C., 750° C., 800° C., 850° C., 900° C., 950° C., 1000° C., 1050° C., or 1100° C., or at a temperature within a range bounded by any two of the foregoing values (e.g., 800-1100° C. or 900-1100° C.). In step (b), the leaching step, the water may be solely water, in which case the resulting lithium sulfate leachate typically has a pH in the range of 9-14 or 12-14, or the water may contain a pH modifying agent (e.g., H₂SO₄ or NaOH) to adjust the pH of the lithium sulfate leachate to a range of, for example, 1-14, 1-13, 1-12, 1-11, 1-8, 1-5, 3-14, 3-13, 3-12, 3-11, 3-8, 3-5, 5-14, 5-13, 5-12, 5-11, 5-8, 7-14, 7-13, 7-12, 7-11, 8-14, 8-13, 8-12, 8-11, 9-14, 9-13, or 9-12. When a carbonate material, such as limestone, is included in the reaction (typically as dry roast), the resulting silicate (e.g., calcium silicate, if calcium carbonate is used) will generally not dissolve in the water phase used for the leaching step (b). Thus, the silicate material can be removed by any suitable separation process (e.g., filtration), thereby leaving the lithium sulfate leachate with substantially no silicate material. The leachate is typically filtered to remove remaining solid particles, thereby rendering the lithium sulfate aqueous solution substantially or completely clear or translucent.

The lithium sulfate aqueous solution, whether obtained from a brine or industrial effluent or produced by the mineral sulfating process described above, can contain lithium ions in the absence of other mineral species, but more typically the lithium ions are in the presence of one or more other mineral species. Some examples of other mineral species include sodium (Na), potassium (K), calcium (Ca), strontium (Sr), and magnesium (Mg). In some embodiments, the lithium sulfate aqueous solution contains at least one ionic species in addition to lithium selected from sodium and/or potassium. In some embodiments, the lithium sulfate aqueous solution contains at least one ionic species in addition to lithium selected from calcium, strontium, and/or magnesium. In some embodiments, the lithium sulfate aqueous solution at the start of step (i) contains at least one ionic species in addition to lithium selected from sodium and potassium, and at least one additional ionic species selected from calcium, strontium, and magnesium. In some embodiments, the lithium sulfate aqueous solution contains lithium in a concentration of at least 1000 ppm, sodium in a concentration of at least 1000 ppm, and potassium in a concentration of at least 1000 ppm. In other embodiments, the lithium sulfate aqueous solution contains lithium in a concentration of less than 1000 ppm (or no more than or less than 500 ppm), sodium in a concentration of at least 1000 ppm, and potassium in a concentration of at least 1000 ppm. In other embodiments, the lithium sulfate aqueous solution contains lithium in a concentration of less than 5000 ppm (or no more than or less than 2500 ppm or 1000 ppm), sodium in a concentration of at least 5,000 ppm or 10,000 ppm, and potassium in a concentration of at least 5,000 ppm or 10,000 ppm.

In a first part of the method, herein referred to as step (i), an aluminum-containing sorbent material (i.e., “sorbent material”) is mixed into the lithium sulfate aqueous solution, as described above, to form a precursor mixture. The sorbent material is generally substantially or completely insoluble in the aqueous solution. In some embodiments, an excess of the sorbent material is used, wherein the term “excess,” as used herein, corresponds to an amount more than sufficient to absorb all lithium in the lithium sulfate aqueous solution. However, continuous processes are also contemplated herein, in which case the sorbent material will remove lithium in batches from a flowing lithium sulfate aqueous solution. The lithium sulfate aqueous solution can have any of the pHs and/or presence of one or more other ionic species described above. The aluminum-containing sorbent material is typically in the form of a powder (e.g., 1-5000 microns).

Some examples of aluminum-containing sorbent materials include Al(OH)₃, MAlO₂, Al₂O₃, MAl(OH)₄, M₂O.Al₂O₃, and AlO(OH), and combinations thereof, wherein M is selected from Na, K, Rb, and Cs. The sorbent material may be completely composed of or may include any one or more of the foregoing exemplary compositions. In one set of embodiments, the sorbent material is or includes an aluminum trihydroxide, i.e., Al(OH)₃, which may be in the form of, for example, gibbsite (predominantly or exclusively γ-Al(OH)₃), bayerite (predominantly or exclusively a-Al(OH)₃ or β-Al(OH)₃), wherein gibbsite may be monoclinic or triclinic, and bayerite is generally monoclinic. The sorbent material may alternatively be a clay material that includes an aluminum trihydroxide component. Some examples of such clay materials include kaolinite, montmorillonite, and illite types of clays. In a second set of embodiments, the sorbent material is or includes an aluminate of the composition MAlO₂, such as sodium aluminate (NaAlO₂), potassium aluminate (KAlO₂), rubidium aluminate (RbAlO₂), or cesium aluminate (CsAlO₂). In a third set of embodiments, the sorbent material is or includes Al₂O₃ (e.g., α-, β-, or γ-alumina or corundum). In a third set of embodiments, the sorbent material is or includes a MAl(OH)₄ composition, such as NaAl(OH)₄ or KAl(OH)₄. In a fourth set of embodiments, the sorbent material is or includes a M₂O.Al₂O₃ composition, such as Na₂O.Al₂O₃ or K₂O.Al₂O₃. In a fifth set of embodiments, the sorbent material is or includes an aluminum oxide-hydroxide composition, such as AlO(OH), which may be, for example, boehmite (γ-AlO(OH)) or diaspore (α-AlO(OH)). The sorbent material may also be or include bauxite, the primary ore of aluminum. Bauxite is known to contain gibbsite, boehmite, and diaspore.

In a second step (step ii), the precursor mixture containing the sorbent material and lithium sulfate aqueous solution is heated to a temperature of 50-200° C. to result in selective formation of a solid lithium-aluminum complex and mother liquor. In different embodiments, the precursor mixture is heated to a temperature of precisely or about, for example, 50° C., 60° C., 70° C., 75° C., 80° C., 85° C., 90° C., 95° C., 100° C., 125° C., 150° C., 175° C., or 200° C., or at a temperature within a range bounded by any two of the foregoing values (e.g., 50-200° C., 50-150° C., 50-100° C., 50-90° C., 60-200° C., 60-150° C., 60-100° C., 60-90° C., 70-200° C., 70-150° C., 70-100° C., 70-90° C., 80-200° C., 80-150° C., 80-100° C., 100-200° C., 100-150° C., or 150-200° C.). The precursor mixture is heated at any of the foregoing temperatures for a suitable period of time, typically at least 1 hour, 1.5 hours, 2 hours, 2.5 hours, 3 hours, 4 hours, 5 hours, or 6 hours, or a time within a range between any two of these values.

The resulting lithium-aluminum complex at the end of step (ii) may have any composition containing lithium and aluminum, such as, for example, a lithium aluminum layered double hydroxide (LDH) composition, which may have the formula (1/x)LiₓY.2Al(OH)₃, wherein Y is OH or SO₄; x is 1 when Y is OH; and x is 2 when Y is SO₄. A range of LDH materials are described in detail in, for example, L. Li et al., Johnson Matthey Technol. Rev., 62(2), 161-176, 2018 and V. P. Isupov, Journal of Structural Chemistry, 40(5), 672-685, 1999, the contents of which are herein incorporated by reference in their entirety. In some embodiments, the lithium-aluminum complex formed at the end of step (ii) is amorphous. In some embodiments, the lithium-aluminum complex formed at the end of step (ii) is partially or completely crystalline (i.e., at least partially crystalline), wherein the term “crystalline” typically is or includes “polycrystalline”. A crystalline product may be obtained by, for example, permitting the heated mixture at the end of step (ii) to gradually cool, thereby permitting the lithium-aluminum complex to gradually form over time as crystals, as the precursor mixture gradually cools.

The mother liquor corresponds to the lithium sulfate aqueous solution that has undergone treatment with the sorbent material in step (ii). In the process, the mother liquor at the end of step (ii) contains a substantially reduced concentration of lithium compared to the lithium sulfate aqueous solution at the start of step (i). In a first set of embodiments, the lithium concentration in the mother liquor, at the end of step (ii), is no more than 20% of the lithium concentration in the lithium sulfate aqueous solution at the start of step (i). In a second set of embodiments, the lithium concentration in the mother liquor, at the end of step (ii), is no more than 10% of the lithium concentration in the lithium sulfate aqueous solution at the start of step (i). In a third set of embodiments, the lithium concentration in the mother liquor, at the end of step (ii), is no more than 5% of the lithium concentration in the lithium sulfate aqueous solution at the start of step (i). In a fourth set of embodiments, the lithium concentration in the mother liquor, at the end of step (ii), is no more than 1% of the lithium concentration in the lithium sulfate aqueous solution at the start of step (i). In any of the foregoing first to fourth embodiments, the lithium sulfate aqueous solution at the start of step (i) includes lithium and at least one of sodium and potassium, and the lithium concentration in the mother liquor at the end of step (ii) is no more than 20%, 10%, 5%, or 1% of the lithium concentration in the lithium sulfate aqueous solution at the start of step (i), while concentrations of sodium and potassium in the mother liquor at the end of step (ii) remain substantially unchanged. In any of the foregoing first to fourth embodiments, the lithium sulfate aqueous solution at the start of step (i) may alternatively or in addition include one or more of calcium, strontium, and magnesium and the lithium concentration in the mother liquor at the end of step (ii) is no more than 20%, 10%, 5%, or 1% of the lithium concentration in the lithium sulfate aqueous solution at the start of step (i), while concentrations of calcium, strontium, and magnesium in the mother liquor at the end of step (ii) remain substantially unchanged.

In some embodiments, the method further includes a step (iii) of recovery of the lithium from the lithium-aluminum complex after step (ii). The recovery step may involve recovering isolated lithium salt from the solid lithium-aluminum complex by heating the solid lithium-aluminum complex in water or aqueous solution at a temperature of 50-100° C. to result in delithiation of the solid lithium-aluminum complex with transfer of the lithium salt from the solid lithium-aluminum complex to the water or aqueous solution, along with production (or regeneration) of aluminum hydroxide (typically, Al(OH)₃) solid. The formed aluminum hydroxide may serve as regenerated sorbent material, which can be recycled back into the process in step (i). When treating the lithium-aluminum complex with neutral or acidified water, the recovered isolated lithium salt is typically lithium sulfate. In the case where lithium carbonate is desired, the lithium-aluminum complex may be treated with a solution of aqueous sodium carbonate or bicarbonate or carbon dioxide. In the case where lithium hydroxide is desired, the lithium-aluminum complex may be treated with alkalized water having a pH of at least 9, 10, 11, or 12.

Examples have been set forth below for the purpose of illustration and to describe certain specific embodiments of the invention. However, the scope of this invention is not to be in any way limited by the examples set forth herein.

### EXAMPLES

Lithium Extraction Process

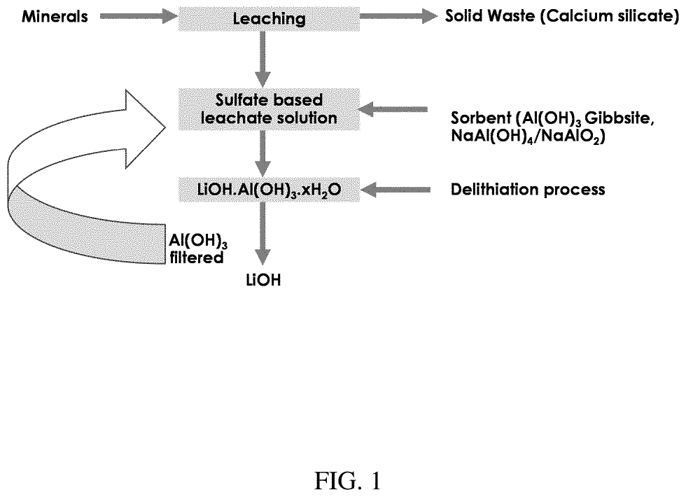

The schematics of a process to selectively extract lithium from leachate sulfate solution is shown in FIG. 1. The leachate solution was filtered to a clear solution. The leachate sulfate solution had a pH close to 12-14 range with Li₂SO₄ concentration of 1000-2500 ppm; Na₂SO₄ concentration of 50,000 ppm; K₂SO₄ of 20,000 ppm. Gibbsite, Al(OH)₃ (similarly, any form of hydroxides and alumina, Al₂O₃, can be used) or sodium aluminate, NaAlO₂ (or NaAl(OH)₄) were added into the leachate solution. By this process, LiOH.2Al(OH)₃.xH₂O (LDH) was exclusively formed with Na, K, and other ions remaining in the solution. In addition, small portions of 0.5Li₂SO₄.2Al(OH)₃.xH₂O (LDH sulfate) were present. LDH was filtered and lithium unloaded from the LDH by delithiation, achieved by heating or treating the LDH with a small amount of lithium hydroxide solution, which led to LiOH product.

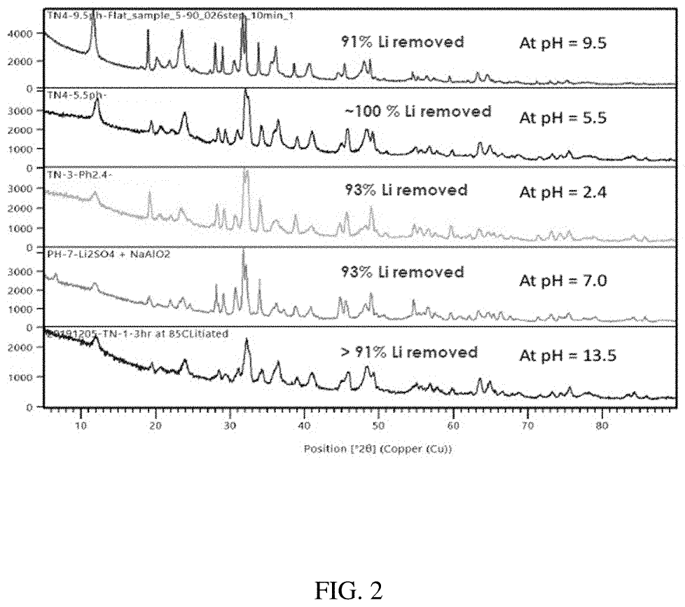

Based on the lithium concentration present in the leachate solution, 1:2 moles of sodium aluminate was added to the leachate solution, LDH was precipitated. Sodium aluminate was synthesized by reacting stoichiometric sodium hydroxide solution with gibbsite at 50-75° C., filtered, and dried. Sodium aluminate was used as the precipitating agent by adding 0.58 g solid to 10 mL leachate liquid solution and reacted at 85° C. for 1-12 hours. After that, the resulting precipitant was filtered, dried, and characterized. The mother liquor was tested for ICP. In addition, the solution pH was also varied (2.4, 5.5, 7.0, 9.5, and original solution of 13.5) and tested with sodium aluminate. ICP-OES results indicate that more than 91% lithium can be selectively removed from the leachate solution. The XRD patterns of the precipitates and ICP results are shown in FIG. 2. Notably, pure LDH was formed at all pH solutions. However, at a pH of 9.5, highly pure and crystalline LDH was obtained.

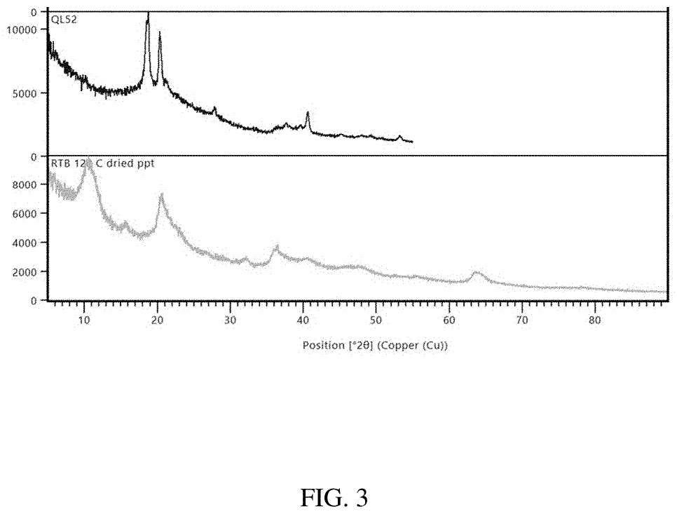

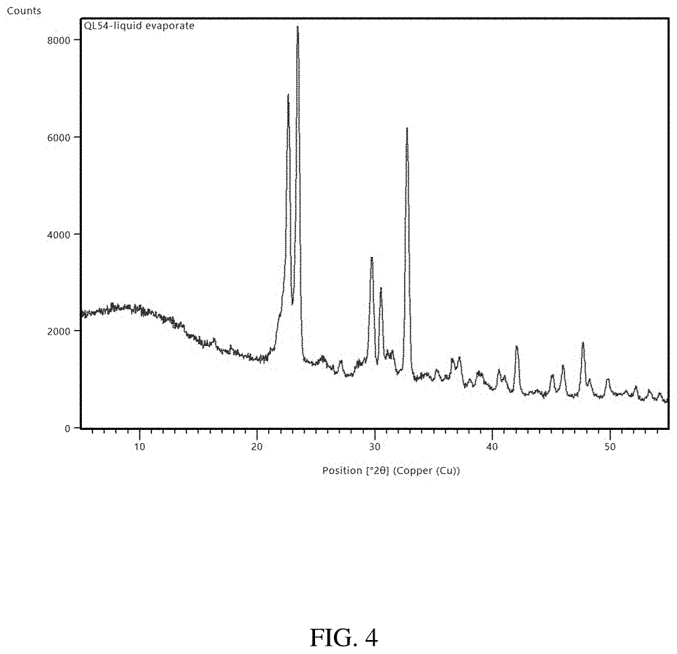

In another experiment, about 2.2 g of gibbsite (aluminum hydroxide: Al(OH)₃) sorbent was added into 20 mL of lithium sulfate leachate solution and heat-treated at 85° C. for 2 hours. This step recovered nearly 100% lithium by forming lithium aluminum double hydroxide sulfate (LDH-sulfate) from the leachate solution, with results shown in FIG. 3. After washing the precipitate with DI (deionized) water a few times to remove any unwanted salts, ˜0.25 g LDH sulfate was treated with DI water at 85° C. in air in a Schlenk line for 2 hours. This step was repeated three times. After each step, supernatant liquid was removed and analyzed by ICP followed by the addition of fresh 25 ml DI water for the next step. After the first step, ˜60-70% lithium was recovered from the LDH-sulfate followed by ˜10-20% lithium in the second step and ˜5-10% lithium in the third step, respectively. Greater than 98% lithium was recovered after three steps of the delithiation process. No reagent chemicals were added either during the lithiation or delithiation process. In addition, no aluminum was detected in the mother liquor. Al(OH)₃ (as gibbsite) was recovered as the precipitate (see FIG. 3). The presence of hydrated lithium sulfate (Li2SO4) was found to be present in the evaporated mother liquor after delithiation (see FIG. 4). Similarly, Na₂CO₃ (sodium carbonate) can be added to the mother liquor to precipitate Li₂CO₃ (lithium carbonate) as the final product.

In addition to the sulfate leachate stream, lithium can be present in other streams, such as halides, phosphates, nitrates, hydroxide, bicarbonates, and carbonates that are generated from clay minerals, ambient brines, geothermal brines, recycled battery electrodes, hard rock minerals, and lithium sources. The leachate stream can be at any pH ranging from 1 to 14. The alkaline nature of the leachate can be close to 5 M (high pH of 12-14) or even 0.1 M (low pH of 9-11) range. In addition, the leachate can also be neutral (pH 5-7) or even acidic (pH 1-5). The sorbent can also be or include other aluminates, such as MAlO₂ or MAl(OH)₄, where M may be, for example, Na, K, Rb, or Cs.

While there have been shown and described what are at present considered the preferred embodiments of the invention, those skilled in the art may make various changes and modifications which remain within the scope of the invention defined by the appended claims.

What is claimed is:

1. A method of selectively extracting lithium from a lithium sulfate aqueous solution, the method comprising:
(i) mixing an aluminum-containing sorbent material into the lithium sulfate aqueous solution to form a precursor mixture, wherein the aluminum-containing sorbent material is an aluminum hydroxide, aluminum oxide, or combination thereof; and
(ii) heating the precursor mixture to a temperature of 50-200° C. to result in selective formation of a solid lithium-aluminum complex and mother liquor.

2. The method of claim 1, wherein, preceding step (i), the lithium sulfate aqueous solution is produced by:
(a) heating lithium-containing mineral at a temperature of 600-1100° C. in the presence of a sulfating reactant to form a sulfated solid product;
(b) leaching the sulfated solid product with water or an aqueous solution to form a leachate;
and
(c) filtering the leachate from solids to produce the lithium sulfate aqueous solution.

3. The method of claim 2, wherein the sulfating reactant is selected from the group consisting of gypsum, alkali sulfates, alkaline earth sulfates, and aluminum sulfate.

4. The method of claim 1, wherein the lithium sulfate aqueous solution at the start of step (i) comprises lithium in a concentration of at least 1000 ppm, sodium in a concentration of at least 1000 ppm, and potassium in a concentration of at least 1000 ppm.

5. The method of claim 1, wherein the lithium sulfate aqueous solution at the start of step (i) comprises lithium in a concentration of less than 1000 ppm, sodium in a concentration of at least 1000 ppm, and potassium in a concentration of at least 1000 ppm.

6. The method of claim 1, wherein the lithium sulfate aqueous solution at the start of step (i) comprises lithium in a concentration of less than 5000 ppm, sodium in a concentration of at least 10,000 ppm, and potassium in a concentration of at least 10,000 ppm.

7. The method of claim 4, wherein the lithium sulfate aqueous solution at the start of step (i) comprises at least one ionic species in addition to lithium selected from sodium and potassium, and at least one additional ionic species selected from calcium, strontium, and magnesium.

8. The method of claim 1, wherein the lithium concentration in the mother liquor, at the end of step (ii), is no more than 20% of the lithium concentration in the lithium sulfate aqueous solution at the start of step (i).

9. The method of claim 8, wherein the lithium sulfate aqueous solution at the start of step (i) comprises lithium, sodium, and potassium, and the lithium concentration in the mother liquor at the end of step (ii) is no more than 20% of the lithium concentration in the lithium sulfate aqueous solution at the start of step (i), while concentrations of sodium and potassium in the mother liquor at the end of step (ii) remain substantially unchanged.

10. The method of claim 1, wherein the lithium concentration in the mother liquor, at the end of step (ii), is no more than 10% of the lithium concentration in the lithium sulfate aqueous solution at the start of step (i).

11. The method of claim 10, wherein the lithium sulfate aqueous solution at the start of step (i) comprises lithium, sodium, and potassium, and the lithium concentration in the mother liquor at the end of step (ii) is no more than 10% of the lithium concentration in the lithium sulfate aqueous solution at the start of step (i), while concentrations of sodium and potassium in the mother liquor at the end of step (ii) remain substantially unchanged.

12. The method of claim 1, wherein the lithium concentration in the mother liquor, at the end of step (ii), is no more than 5% of the lithium concentration in the lithium sulfate aqueous solution at the start of step (i).

13. The method of claim 12, wherein the lithium sulfate aqueous solution at the start of step (i) comprises lithium, sodium, and potassium, and the lithium concentration in the mother liquor at the end of step (ii) is no more than 5% of the lithium concentration in the lithium sulfate aqueous solution at the start of step (i), while concentrations of sodium and potassium in the mother liquor at the end of step (ii) remain substantially unchanged.

14. The method of claim 1, wherein the aluminum-containing sorbent material is selected from the group consisting of Al(OH)₃, MAlO₂, Al₂O₃, MAl(OH)₄, M₂O.Al₂O₃, and AlO(OH), wherein M is selected from the group consisting of Na, K, Rb, and Cs.

15. The method of claim 1, wherein the aluminum-containing sorbent material comprises Al(OH)₃.

16. The method of claim 15, wherein the Al(OH)₃ is in the form of gibbsite.

17. The method of claim 1, wherein the aluminum-containing sorbent material comprises MAl(OH)₄ or MAlO₂.

18. The method of claim 1, wherein the aluminum-containing sorbent material comprises NaAl(OH)₄ or NaAlO₂.

19. The method of claim 1, wherein the lithium-aluminum complex formed in step (ii) has the formula (1/x)LiₓY.2Al(OH)₃, wherein Y is OH or SO₄; x is 1 when Y is OH; and x is 2 when Y is SO₄.

20. The method of claim 1, wherein the pH of the lithium sulfate aqueous solution at the start of step (i) is within a range of 1-14.

21. The method of claim 1, wherein the pH of the lithium sulfate aqueous solution at the start of step (i) is within a range of 8-14.

22. The method of claim 1, wherein the pH of the lithium sulfate aqueous solution at the start of step (i) is within a range of 8-11.

23. The method of claim 1, wherein the pH of the lithium sulfate aqueous solution at the start of step (i) is within a range of 3-8.

24. The method of claim 1, wherein the lithium-aluminum complex formed at the end of step (ii) is at least partially crystalline.

25. The method of claim 1, wherein the lithium-aluminum complex formed at the end of step (ii) is amorphous.

26. The method of claim 1, wherein, at the end of step (ii), the heated mixture is permitted to gradually cool, and the lithium-aluminum complex forms gradually over time in the form of crystals as the precursor mixture gradually cools.

27. The method of claim 1, wherein the temperature in step (ii) is 50-100° C.

28. The method of claim 1, wherein the method further comprises, after step (ii):
(iii) recovering isolated lithium salt from the solid lithium-aluminum complex by heating the solid lithium-aluminum complex in water at a temperature of 50-100° C. to result in delithiation of the solid lithium-aluminum complex with transfer of the lithium salt from the solid lithium-aluminum complex to the water, along with production of aluminum hydroxide solid.
